(19) United States
(12) Patent Application Publication
(10) Pub. No.: US 2025/0096354 A1
(43) Pub. Date: Mar. 20, 2025

(54) BATTERY MODULE, IMMERSION TEMPERED TRACTION BATTERY AND BATTERY-ELECTRIC VEHICLE

(71) Applicant: MAHLE International GmbH, Stuttgart (DE)

(72) Inventors: Dieter Reisinger, Muehlacker (DE); Dragos-Cristian Iancu, Hitzhofen (DE); Thomas Klambach, Ostfildern (DE); Eduard Reimer, Fellbach (DE)

(21) Appl. No.: 18/822,066

(22) Filed: Aug. 30, 2024

(30) Foreign Application Priority Data
Sep. 1, 2023 (DE) 10 2023 208 444.9

(51) Int. Cl. H01M 10/6556; B60L 50/64; B60L 58/24; H01M 10/625; H01M 10/643; H01M 10/6554; H01M 10/6568; H01M 50/213; H01M 50/249; H01M 50/258

(52) U.S. Cl. CPC H01M 10/6556; B60L 50/64; B60L 58/24; H01M 10/625; H01M 10/643; H01M 10/6554; H01M 10/6568; H01M 50/213; H01M 50/249; H01M 50/258; H01M 2220/20

(57) ABSTRACT

A battery module for an immersion-tempered traction battery for a battery-powered vehicle may include a fluid distributor plate and a housing base, which may together delimit a housing interior in which a plurality of battery cells are arranged. The fluid distributor plate and the housing base may each include at least one temperature control fluid inlet channel section and at least one temperature control fluid outlet channel section. A first opening may be disposed in at least one of the temperature control fluid inlet channel sections. A temperature control fluid may be suppliable to the housing interior via the first opening. A second opening may be disposed in at least one of the temperature control fluid outlet channel sections. The temperature control fluid and/or gas may be dischargeable from the housing interior via the second opening.

### CROSS-REFERENCE TO RELATED APPLICATION

This application claims priority to German Patent Application No. DE 10 2023 208 444.9, filed Sep. 1, 2023, the contents of which is hereby incorporated by reference in its entirety.

### TECHNICAL FIELD

The present invention relates to a battery module for an immersion-tempered traction battery for a battery-powered vehicle, an immersion-tempered traction battery for a battery-powered vehicle with at least two such battery modules, and a battery-powered vehicle with such an immersion-tempered traction battery.

### BACKGROUND

A traction battery is used to power the electric motor drive of a battery-powered vehicle. Typically, a traction battery of this type comprises a battery housing that tightly encloses a housing interior. A plurality of electrochemical battery cells are arranged in the housing interior. In an immersion-tempered traction battery or in a traction battery with immersion temperature control, heat is transferred using a thermally conductive dielectric temperature control fluid, which is preferably a liquid. The temperature control fluid is applied directly to electrical components of the traction battery, in particular the battery cells, which enables particularly efficient heat transfer. The temperature control that can be achieved with the aid of immersion temperature control can be cooling or heating of the traction battery as required, so that heat can be dissipated from the traction battery or supplied to the traction battery via the temperature control fluid as required.

In an immersion-tempered traction battery of this type, a temperature control path is formed in the battery housing, which guides the dielectric temperature control fluid through the housing interior in such a way that the battery cells are in direct contact with the temperature control fluid.

In order to achieve the highest possible performance of an immersion-cooled traction battery, it is necessary to control the temperature of the battery as required, wherein uniform temperature control of all battery cells and the avoidance of so-called hotspots is particularly desirable. Furthermore, in order to be able to provide traction batteries for a wide variety of vehicle series with different performance requirements, for example, it is desirable to design them as flexibly as possible in terms of structure, for example the number of battery cells used, which is not possible with traction batteries known to date, which have to be configured and manufactured separately for the respective application.

### SUMMARY

The present invention therefore deals with the problem of specifying a battery module which, in addition to uniform temperature control of the battery cells arranged therein, also enables simple production and a high degree of flexibility with regard to the formation of variants of a traction battery.

According to the invention, this problem is solved by the subject matter of independent claim(s). Advantageous embodiments are the subject matter of the dependent claim(s).

The present invention is based on the general idea of designing a battery module in such a way that it can be manufactured by essentially simple plugging together and that, when plugged together, temperature control fluid channels are created which simultaneously enable optimum temperature control, i.e., for example heating or cooling, of battery cells of the battery module. However, the battery module according to the invention can not only be easily manufactured, but can also form part of a modular system as a ready-made battery module, so that a traction battery can be assembled comparatively easily from a plurality of such battery modules, which can be adapted extremely flexibly to different desired outputs and/or sizes due to the modular structure. The optimum temperature control of the battery cells of the battery module and the simple assembly of the same by simply plugging together a fluid distributor plate with a housing base and the simple combination of an assembled battery module with other battery modules enables a battery module to be created that is significantly improved in terms of its performance and significantly more flexible in terms of its use. The battery module according to the invention for an immersion-tempered traction battery of a battery-powered vehicle has a fluid distributor plate and a housing base, between which a plurality of battery cells are arranged. The fluid distributor plate and the housing base enclose a housing interior in which the battery cells are arranged. The battery cells can, for example, be designed as round cells and therefore have a longitudinal axis which, when installed, usually extends transversely to a plane of the fluid distributor plate or the housing base. The housing base comprises a raised edge that is tightly connected to the fluid distributor plate and delimits the interior of the housing. The fluid distributor plate has at least a first temperature control fluid inlet channel section and a first temperature control fluid outlet channel section. The housing base in turn has at least a second temperature control fluid inlet channel section and a second temperature control fluid outlet channel section, wherein a first opening is provided in at least one of the first and/or second temperature control fluid inlet channel sections, via which temperature control fluid can pass from the respective temperature control fluid inlet channel section and the fluid distributor plate into the housing interior to the battery cells to be temperature-controlled. It is also theoretically possible that the temperature control fluid does not flow through the first opening via the fluid distributor plate, but instead flows directly into the housing interior to the battery cells. A second opening is provided in at least one of the temperature control fluid outlet channel sections, via which temperature control fluid and/or gases can be discharged from the housing interior. The second opening in at least one temperature control fluid outlet channel section thus also makes it possible to vent the housing interior, which prevents exploding or at least reduces the risk of exploding, particularly in the event of thermal runaway of one or a plurality of battery cells. According to the invention, the fluid distributor plate is connected to the housing base in such a way that at least a first temperature control fluid inlet channel section of the fluid distributor plate is connected to an associated second temperature control fluid inlet channel section of the housing base via a first plug-in connection. At the same time, at least a first temperature control fluid outlet channel section of the fluid distributor plate is connected to an associated second temperature control fluid outlet channel section of the housing base via a second plug-in connection. In the best case, the first and second temperature control fluid inlet channel sections and the first and second temperature control fluid outlet channel sections are simply inserted into one another, thereby creating a continuous temperature control fluid inlet channel or outlet channel. All in all, the battery module according to the invention can thus on the one hand achieve optimum cooling of the battery cells arranged therein, in particular uniform temperature control of the same, whereby in particular hotspots can be avoided and the performance of the battery module can be increased, while on the other hand the first and second plug-in connections enable comparatively simple assembly of the battery module.

In an advantageous further development of the battery module according to the invention, a first temperature control fluid inlet channel section of the fluid distributor plate is inserted into an associated second temperature control fluid inlet channel section of the housing base and a first temperature control fluid outlet channel section of the fluid distributor plate is inserted into an associated second temperature control fluid outlet channel section of the housing base. This makes it possible, for example, to place the battery cells, in particular round cells, held by a cell holder on the housing base and then to attach the fluid distributor plate in such a way that the first temperature control fluid inlet channel section is inserted into the second temperature control fluid inlet channel section and the first temperature control fluid outlet channel section is inserted into the second temperature control fluid outlet channel section. Sealing in the area of the first plug-in connection and/or the second plug-in connection can be achieved via a precisely fitting plug-in connection or via a separate sealing element. By connecting the first and second plug-in connection, the housing base is also aligned relative to the fluid distributor plate.

A predefined axial play or radial play in the area of the first plug-in connection and/or the second plug-in connection can also be used to easily compensate for manufacturing tolerances.

In a particularly preferred embodiment of the battery module according to the invention, the first opening is adjacent to the fluid distributor plate or is arranged in the area of the fluid distributor plate. This makes it possible to feed tempering fluid, in some cases a cooling oil, to the individual battery cells arranged in the battery module and to cool them optimally. Via the first opening, temperature control fluid from the temperature control fluid inlet channel section enters a fluid distribution system, which is formed by the fluid distributor plate and an intermediate plate, and from there via passage openings into the housing interior to the battery cells. Of course, a plurality of such first openings can also be arranged in the area of the first and/or second temperature control fluid inlet channel section, whereby individual temperature control, in particular also temperature control of so-called hotspots as required, is easily possible. The first opening can generally also be arranged in such a way that the temperature control fluid reaches the battery cells directly in the housing interior, in particular without going via the fluid distributor plate.

In a particularly preferred embodiment, the second opening is adjacent to the fluid distributor plate. When installed, the second opening should be clearly above the first opening or the first openings, which also allows venting or degassing. This can reduce the consequences of thermal runaway of a battery cell in particular.

Conveniently, the fluid distributor plate has two first temperature control fluid inlet channel sections and a first temperature control fluid outlet channel section, while the housing base has two second temperature control fluid inlet channel sections and a second temperature control fluid outlet channel section. The flow cross-section of the temperature control fluid inlet channel sections corresponds to the flow cross-section of the temperature control fluid outlet channel section, wherein the flow cross-section of the temperature control fluid outlet channel section can even be larger than the flow cross-section of the temperature control fluid inlet channel sections, for example to reliably enable degassing in the event of a thermal runaway. The two first temperature control fluid inlet channel sections can be arranged in the lower corners of a cuboid battery module, while the temperature control fluid outlet channel can be arranged at the top center of the respective battery module on the opposite side of the temperature control fluid inlet channel sections.

In another advantageous embodiment of the battery module, the battery cells are held by a cell holder. Such a cell holder can, for example, be a plastic injection-molded part into which the respective battery cells are inserted/clipped. For this purpose, the cell holder can, for example, have receptacles that complement the outer contour of the battery cells, into which the respective battery cells are inserted with a positive fit. A cell holder of this type ensures the alignment and arrangement of the individual battery cells in relation to each other, which in particular ensures that the individual battery cells are spaced apart. This also allows the cross-section of temperature control fluid channels between the individual battery cells to be maintained, enabling reliable and, in particular, uniform temperature control of the individual battery cells.

In a further advantageous embodiment of the battery module according to the invention, the fluid distributor plate has a plurality of passage openings for tempering fluid as well as an intermediate plate which, together with the fluid distributor plate, forms a fluid distribution channel system. Temperature control fluid can be supplied to the individual battery cells to be tempered not only directly via a first opening in the respective temperature control fluid inlet channel section, but also via the fluid distributor plate itself, which enables individual and needs-based cooling of the individual battery cells. By supplying temperature control fluid to the battery cells over a large area, for example via a plurality of passage openings, so-called dead water areas can also be avoided in particular, in which there is insufficient exchange of temperature control fluid and so-called hotspots can form as a result.

The present invention is further based on the general idea of providing an immersion-tempered traction battery for a battery-powered vehicle, comprising at least a first battery module according to the preceding paragraphs and a second battery module according to the preceding paragraphs, wherein the at least two battery modules are connected to each other in such a way that a second tempering fluid inlet channel section of the housing base of the first battery module is connected in a communicating manner to a first tempering fluid inlet channel section of the fluid distributor plate of the second battery module, in particular is placed axially thereon or inserted therein, and wherein a second tempering fluid outlet channel section of the housing base of the first battery module is connected in a communicating manner to a first tempering fluid outlet channel section of the fluid distributor plate of the second battery module, in particular is placed axially thereon or inserted therein. Depending on the desired performance of the immersion-tempered traction battery, different numbers of battery modules can be provided, which can be coupled together. The battery modules according to the invention, which can be arranged in almost any number in series, allow the performance of the immersion-tempered traction battery to be customized. If a higher output is required, more battery modules can be assembled. The modular system created by the battery modules according to the invention thus allows an extremely flexible response to a wide range of desired outputs and/or size dimensions of an immersion-tempered traction battery.

In a further advantageous embodiment of the traction battery according to the invention, the battery cells are arranged horizontally when installed. A horizontal arrangement of this kind can achieve particularly uniform flushing of the battery cells to be tempered with tempering fluid and thus particularly uniform cooling of the same.

In a particularly preferred embodiment of the traction battery according to the invention, the temperature control fluid inlet channel sections are located below the temperature control fluid outlet channel sections when installed. This enables a temperature-supported flow of tempering fluid through the housing interior, which, for example, flows into the housing interior via the first opening(s) at the bottom to cool the battery cells to be tempered and then heats up as it continues to flow through the housing interior through the battery cells arranged there and flows upwards to the tempering fluid outlet channel section and its second opening(s). The temperature control fluid, which heats up as it flows through the housing interior, therefore flows essentially from bottom to top through the housing interior and absorbs heat from the battery cells. At the same time or alternatively, an essentially axial flow through the housing interior takes place through the passage openings provided in the fluid distributor plate, wherein “axial” refers to an axis of the temperature control fluid channels.

The present invention is further based on the general idea of equipping a battery-powered vehicle with such an immersion-tempered traction battery and thereby transferring the advantages described with respect to the immersion-tempered traction battery or the battery modules arranged therein according to the invention to the battery-powered vehicle. Specifically, the advantages lie in the fact that the traction battery for the battery-powered vehicle can be manufactured extremely flexibly by assembling different numbers of battery modules and also enables optimum temperature control, in particular optimum cooling of the individual battery cells of the traction battery.

Other important features and advantages of the invention can be seen from the dependent claims, from the drawings, and from the associated description of the figure based on the drawings.

It is understood that the above-mentioned features and those yet to be explained below can be used not only in the combination indicated in each case, but also in other combinations or on their own, without deviating from the scope of the invention defined by the claims. The components of a superordinate unit, such as a device, an apparatus, or an arrangement, which are described separately, having been mentioned above or to be mentioned below, can represent separate components of this unit or can form integral areas or sections of this unit, even if this is shown differently in the drawings.

Preferred exemplary embodiments of the invention are shown in the drawings by way of example and will be explained in more detail in the following description, wherein identical reference numbers refer to identical or similar or functionally identical elements.

### BRIEF DESCRIPTION OF THE DRAWINGS

They show, schematically in each case,

FIG. 1 is an exploded view of a traction battery of a battery-powered vehicle according to the invention,

FIG. 2 is a top view of a traction battery according to the invention, illustrating the flow of a tempering fluid,

FIG. 3 is a sectional view of a traction battery according to the invention in the area of a tempering fluid inlet channel,

FIG. 4 is a sectional view of a traction battery according to the invention in the area of a temperature control fluid outlet channel.

### DETAILED DESCRIPTION

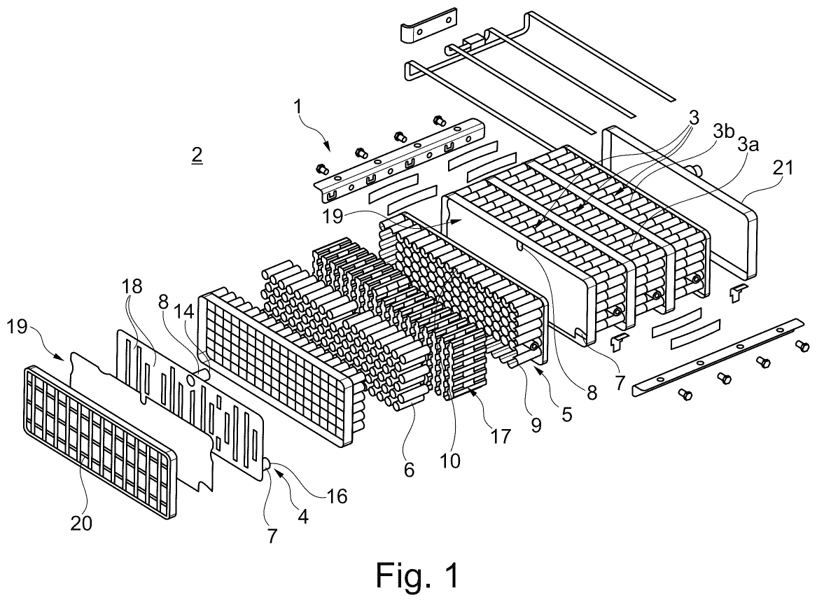

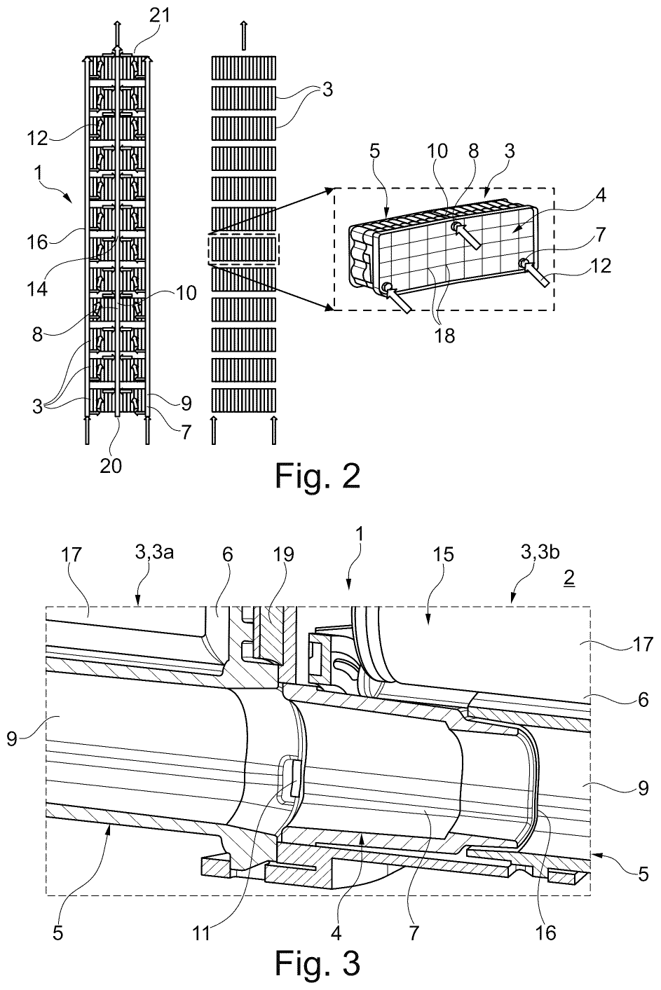

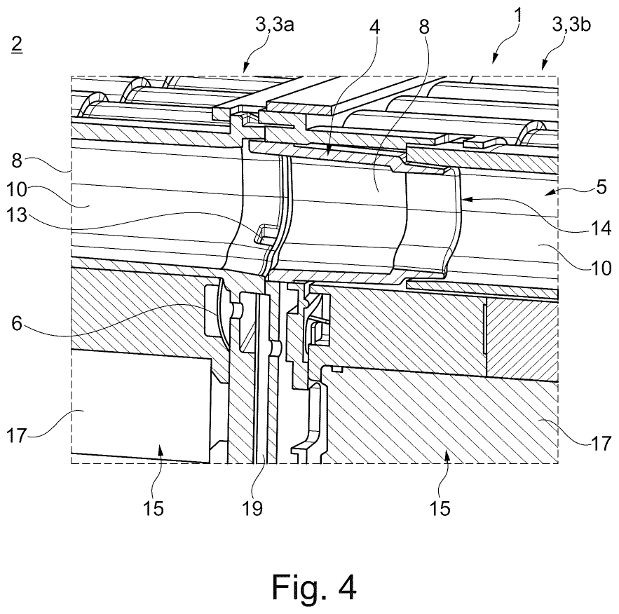

As shown in FIG. 1, an immersion-tempered traction battery 1 according to the invention for a battery-powered vehicle 2, which is not shown in detail, has a plurality of battery modules 3 (see also FIGS. 2 through 4), which are connected to each other in a fluid-tight manner. Each of the battery modules 3 according to the invention has a fluid distributor plate 4, a housing base 5 and battery cells 6 arranged between them in a housing interior 15. The fluid distributor plate 4 has at least one first temperature control fluid inlet channel section 7, according to FIGS. 1 and 2 two such temperature control fluid inlet channel sections 7, as well as a first temperature control fluid outlet channel section 8. The housing base 5 has at least one second temperature control fluid inlet channel section 9, in the embodiment shown two such second temperature control fluid inlet channel sections 9, as well as a second temperature control fluid outlet channel section 10. A first opening 11 is provided in at least one temperature control fluid inlet channel section 7, 9, through which temperature control fluid 12 can pass directly or indirectly via the fluid distributor plate 4 into the housing interior 15 to the battery cells 6. At least one second opening 13 (see FIG. 4) is provided in at least one temperature control fluid outlet channel section 8, 10, via which temperature control fluid 12 and/or gases can be discharged from the housing interior 15. The fluid distributor plate 4 is now connected to the housing base 5 in such a way that at least a first temperature control fluid inlet channel section 7 of the fluid distributor plate 4 is connected via a first plug-in connection 16 to an associated second temperature control fluid inlet channel section 9 of the housing base 5 (see also FIG. 3), while at least a first temperature control fluid outlet channel section 8 of the fluid distributor plate 4 is connected via a second plug-in connection 14 (see FIG. 3) to an associated second temperature control fluid outlet channel section 10 of the housing base 5 (see FIG. 4). The battery module 3 according to the invention can thus be assembled by simply plugging the fluid distributor plate 4 together with the housing base 5, wherein the battery cells 6 is initially arranged between them.

The first temperature control fluid inlet channel section 7 of the fluid distributor plate 4 is usually inserted into the associated second temperature control fluid inlet channel section 9 of the housing base 5 via the first plug-in connection 16, while the first temperature control fluid outlet channel section 8 of the fluid distributor plate 4 is inserted into the associated second temperature control fluid outlet channel section 10 of the housing base 5. In this way, a comparatively simple, in particular fluid-tight, connection of the respective temperature control fluid inlet channel sections 7, 9 or temperature control fluid outlet channel sections 8, 10 can be achieved.

A predefined axial play or radial play in the area of the first plug-in connection 16 and/or the second plug-in connection 14 can also be used to easily compensate for manufacturing tolerances.

The first opening 11 can be arranged adjacent to the fluid distributor plate 4, but also in its place, while the second opening 13 can also be arranged adjacent to the fluid distributor plate 4. The first opening 11 is located in the joint area of the housing base 5 on the fluid distributor plate 4. The first opening 11 can, for example, be formed by a recess arranged at a longitudinal end of the second temperature control fluid inlet channel section 9 (see FIG. 3), while the second opening 13 can, for example, be formed by a recess arranged at a longitudinal end of the second temperature control fluid outlet channel section 10 (see FIG. 4).

The individual battery cells 6 are held between the distributor plate 4 and the housing base 5, for example by means of a cell holder 17, which also ensures that there is a sufficient flow cross-section for the temperature control fluid 12 between the individual battery cells 6.

Looking at the fluid distributor plate 4, it usually has a plurality of passage openings 18 for temperature control fluid 12 as well as an intermediate plate 19, which together with the fluid distributor plate 4 forms a fluid distribution channel system.

The fluid distribution channel system can be pressurized by a corresponding communicating connection with the respective first temperature control fluid inlet channel section 7 of the fluid distributor plate 4, in particular its first opening 11. The size of the first and/or second opening 11, 13 can also be used to create a throttle point via which a flow velocity can be influenced. The second openings 13 can also be used for venting or degassing, which in particular can reduce the consequences of thermal runaway of one or a plurality of battery cells 6.

The traction battery 1 according to the invention can have a different number of battery modules 3, depending on the desired power and/or size, each of which is connected to each other in a communicating manner. A distributor cover 20 (see FIG. 1) or a collector cover 21 is arranged at the longitudinal end, wherein temperature control fluid 12 is supplied to the individual temperature control fluid inlet channel sections 7, 9 of the respective battery modules 3 via the distributor cover 20. The collector cover 21 in turn is connected to the respective temperature control fluid outlet channel section 8, 10 of the individual battery modules 3 in a communicating manner and drains the temperature control fluid 12 from the traction battery 1.

Within the traction battery 1, at least two battery modules 3 are connected to each other in such a way that a second temperature control fluid inlet channel section 9 of the housing base 5 of a first battery module 3a is inserted into a first temperature control fluid inlet channel section 7 of the fluid distributor plate 4 of a second battery module 3b, while a second temperature control fluid outlet channel section 10 of the housing base 5 of the first battery module 3a is inserted into a first temperature control fluid outlet channel section 8 of the fluid distributor plate 4 of the second battery module 3b.

As can also be seen in FIG. 1, the individual battery cells 6 are arranged horizontally when installed and at the same time the temperature control fluid inlet channel sections 7, 9 are located below the temperature control fluid outlet channel sections 8, 10, which enables temperature-supported transportation of the temperature control fluid 12 in the traction battery 1. First, the comparatively cool tempering fluid 12 is conveyed via the first tempering fluid inlet channel sections 7 into the traction battery 1 and via the fluid distributor plate 4 and its passage openings 18 or directly between the battery cells 6, where it heats up and absorbs heat from the battery cells 6. The temperature control fluid inlet channel sections 7, 9 are located in a respective lower corner area, while the temperature control fluid outlet channel sections 8, 10 are arranged in a central upper area of the respective battery module 3. The temperature control fluid 12 thus flows through the housing interior 15 between the individual battery cells 6 both horizontally and vertically, usually at an angle.

Through the passage openings 18 in the respective fluid distributor plates 4, the housing interior between the individual battery cells 6 is additionally pressurized with tempering fluid 12.

With the battery module 3 according to the invention, it is possible to achieve both simple and optimum temperature control of the battery cells 6, as the temperature is uniform. The battery module 3 is also extremely easy to assemble, as only the battery cells 6 with the cell holder 17 have to be inserted into the housing base 5 and then the fluid distributor plate 4 has to be placed on the housing base 5 and tightly connected to it. At the same time, the simple coupling of a plurality of battery modules 3 means that a traction battery 1 can be designed extremely flexibly in terms of size, which allows a high degree of design freedom.

1. A battery module for an immersion-tempered traction battery for a battery-powered vehicle, comprising:
a fluid distributor plate and a housing base, which together delimit a housing interior in which a plurality of battery cells are arranged;
the fluid distributor plate including at least one first temperature control fluid inlet channel section and at least one first temperature control fluid outlet channel section;
the housing base including at least one second temperature control fluid inlet channel section and at least one second temperature control fluid outlet channel section;
a first opening disposed in at least one of the at least one first temperature control fluid inlet channel section and the at least one second temperature control fluid inlet channel section, a temperature control fluid suppliable to the housing interior, via the first opening; and
a second opening disposed in at least one of the at least one first temperature control fluid outlet channel section and the at least one second temperature control fluid outlet channel section, at least one of the temperature control fluid and gases dischargeable from the housing interior via the second opening;
wherein the fluid distributor plate is connected to the housing base such that the at least one first temperature control fluid inlet channel section is connected, via a first plug-in connection, to the at least one second temperature control fluid inlet channel section and the at least one first temperature control fluid outlet channel section is connected, via a second plug-in connection, to the at least one second temperature control fluid outlet channel section.

2. The battery module according to claim 1, wherein the at least one first temperature control fluid inlet channel section is inserted into the at least one second temperature control fluid inlet channel section and the at least one first temperature control fluid outlet channel section is inserted into the at least one second temperature control fluid outlet channel section.

3. The battery module according to claim 1, wherein the first opening is arranged adjacent to the fluid distributor plate.

4. The battery module according to claim 1, wherein the second opening is arranged adjacent to the fluid distributor plate.

5. The battery module according to claim 1, wherein:
the at least one first temperature control fluid inlet channel section includes two first temperature control fluid inlet channel sections and the at least one first temperature control fluid outlet channel section includes a single first temperature control fluid outlet channel section; and
the at least one second temperature control fluid inlet channel section includes two second temperature control fluid inlet channel sections and the at least one second temperature control fluid outlet channel section includes a second temperature control fluid outlet channel section.

6. The battery module according to claim 1, further comprising a cell holder holding the plurality of battery cells.

7. The battery module according to claim 1, further comprising an intermediate plate, wherein:
the fluid distributor plate includes a plurality of passage openings for the temperature control fluid; and
the intermediate plate, together with the fluid distributor plate, forms a fluid distribution channel system.

8. An immersion-tempered traction battery for a battery-powered vehicle, comprising:
a plurality of battery modules according to claim 1, the plurality of battery modules including a first battery module and a second battery module;
wherein the plurality of battery modules are connected to each other such that the at least one second temperature control fluid inlet channel section of the first battery module is connected in a communicating manner with the at least one first temperature control fluid inlet channel section of the second battery module and the at least one second temperature control fluid outlet channel section of the first battery module is connected in a communicating manner with the at least one first temperature control fluid outlet channel section of the second battery module.

9. The traction battery according to claim 8, wherein the plurality of battery cells of at least one of the plurality of battery modules are arranged horizontally when installed.

10. The traction battery according to claim 8, wherein at least one of the plurality of battery modules is configured such that the at least one first temperature control fluid inlet channel section and the at least one second temperature control fluid inlet channel sections are disposed below the at least one first temperature control fluid outlet channel section and the at least one second temperature control fluid outlet channel sections when installed.

11. A battery-powered vehicle, comprising the immersion-tempered traction battery according to claim 8.

12. A battery module for an immersion-tempered traction battery for a battery-powered vehicle, comprising:
a housing base;
a fluid distributor plate connected to the housing base;
a housing interior delimited by the housing base and the fluid distributor plate;
a plurality of battery cells arranged in the housing interior;
a plurality of temperature control fluid inlet channel sections, at least one of the plurality of temperature control fluid inlet channel sections including a first opening via which a temperature control fluid is suppliable to the housing interior;
a plurality of temperature control fluid outlet channel sections, at least one of the plurality of temperature control fluid outlet channel sections including a second opening via which at least one of the temperature control fluid and gas is dischargeable from the housing interior;
wherein the fluid distributor plate and the housing base each include i) at least one of the plurality of temperature control fluid inlet channel sections and ii) at least one of the plurality of temperature control fluid outlet channel sections;
wherein a first temperature control fluid inlet channel section arranged on the fluid distributor plate is connected, via a first plug-in connection, to a second temperature control fluid inlet channel section arranged on the housing base; and
wherein a first temperature control fluid outlet channel section arranged on the fluid distributor plate is connected, via a second plug-in connection, to a second temperature control fluid outlet channel section arranged on the housing base.

13. The battery module according to claim 12, wherein the first temperature control fluid inlet channel section is disposed at least partially within the second temperature control fluid inlet channel section.

14. The battery module according to claim 12, wherein the first temperature control fluid outlet channel section is disposed at least partially within the second temperature control fluid outlet channel section.

15. The battery module according to claim 12, wherein at least one of the fluid distributor plate and the housing plate includes at least two of the plurality of temperature control fluid inlet channel sections.

16. The battery module according to claim 12, wherein at least one of the fluid distributor plate and the housing plate includes only one of the plurality of temperature control fluid outlet channel sections.

17. The battery module according to claim 12, further comprising an intermediate plate, wherein the intermediate plate and the fluid distributor plate collectively define a fluid distribution channel system.

18. The battery module according to claim 17, wherein the fluid distributor plate includes a plurality of passage openings through which the temperature control fluid is flowable.

19. A battery module for an immersion-tempered traction battery for a battery-powered vehicle, comprising:
a housing base;
a fluid distributor plate connected to the housing base;
a housing interior delimited by the housing base and the fluid distributor plate;
a plurality of battery cells arranged in the housing interior;
a plurality of temperature control fluid inlet channel sections, at least one of the plurality of temperature control fluid inlet channel sections including a first opening via which a temperature control fluid is suppliable to the housing interior;
a plurality of temperature control fluid outlet channel sections, at least one of the plurality of temperature control fluid outlet channel sections including a second opening via which at least one of the temperature control fluid and gas is dischargeable from the housing interior;
wherein a first subset of the plurality of temperature control fluid inlet channel sections and a first subset of the plurality of temperature control fluid outlet channel sections are arranged on the fluid distributor plate;
wherein a second subset of the plurality of temperature control fluid inlet channel sections and a second subset of the plurality of temperature control fluid outlet channel sections are arranged on the housing base;
wherein each of the plurality of temperature control fluid inlet channel sections arranged on the fluid distributor plate is connected, via a plug-in connection, to a respective one of the plurality of temperature control fluid inlet channel sections arranged on the housing base; and
wherein each of the plurality of temperature control fluid outlet channel sections arranged on the fluid distributor plate is connected, via a plug-in connection, to a respective one of the plurality of temperature control fluid outlet channel sections arranged on the housing base.

20. The battery module according to claim 19, wherein:
each of the plurality of temperature control fluid inlet channel sections arranged on the fluid distributor plate is plugged into and disposed at least partially within the respective one of the plurality of temperature control fluid inlet channel sections arranged on the housing base; and
each of the plurality of temperature control fluid outlet channel sections arranged on the fluid distributor plate is plugged into and disposed at least partially within the respective one of the plurality of temperature control fluid outlet channel sections arranged on the housing base.
